(19) United States
(12) Patent Application Publication
(10) Pub. No.: US 2009/0015130 A1
(43) Pub. Date: Jan. 15, 2009

(54) LIGHT EMISSION DEVICE AND DISPLAY DEVICE USING THE LIGHT EMISSION DEVICE AS A LIGHT SOURCE

(75) Inventors: Yoon-Jin Kim, Gyeonggi-do (KR); Jae-Myung Kim, Gyeonggi-do (KR); Kyu-Nam Joo, Suwon-si (KR); Hyun-Ki Park, Gyeonggi-do (KR); So-Ra Lee, Suwon-si (KR); Young-Suk Cho, Gyeonggi-do (KR); Hee-Sung Moon, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd, Suwon-si (KR)

(21) Appl. No.: 12/121,546

(22) Filed: May 15, 2008

(30) Foreign Application Priority Data
Jul. 11, 2007 (KR) 10-2007-69606

(51) Int. Cl. H01J 1/62

(52) U.S. Cl. 313/486

(57) ABSTRACT

A light emission device with improved high voltage stability, and a display device having the light emission device as its light source, the light emission device comprising front and rear substrates disposed to face each other, an electron emission unit disposed on the front substrate and having a plurality of electron emission elements, and a light emission unit including a metal reflective layer formed on the rear substrate and a phosphor layer formed on the metal reflective layer. Each of the electron emission elements includes first electrodes, second electrodes arranged between the first electrodes, and electron emission regions electrically connected to the first electrodes and having a thickness smaller that of the first electrodes.

### CROSS-REFERENCE TO RELATED APPLICATION

This application claims priority to and the benefit of Korean Patent Application No. 10-2007-69606 filed in the Korean Intellectual Property Office on Jul. 11, 2007, the entire content of which is incorporated herein by reference.

### BACKGROUND

1. Technical Field

The present disclosure relates to a light emission device. More particularly, the present disclosure relates to a light emission device that improves the structures of an electron emission unit and a light emission unit, and a display device using the light emission device as a light source.

2. Description of Related Art

There are many different types of light emission devices that radiate visible light. One type of light emission device includes a structure in which an anode electrode and a phosphor layer are disposed on a front substrate and electron emission regions and driving electrodes are disposed on a rear substrate. The front and rear substrates are integrally sealed at their peripheries with a sealing member, and the inner space between the front and rear substrates is evacuated to form a vacuum envelope.

The driving electrodes include cathode electrodes and gate electrodes spaced apart from each other, generally in parallel. The electron emission regions are disposed on the sides of the cathode electrodes that face the gate electrodes. The driving electrodes and the electron emission regions form an electron emission unit.

A metal reflective layer may be disposed on one side of the phosphor layer facing the rear substrate. The metal reflective layer reflects visible light emitted from the phosphor layer toward the rear substrate, back through the front substrate in order to improve the luminance of the light emission device. The anode electrode, the phosphor layer, and the metal reflective layer form a light emission unit.

The light emission device is driven by supplying driving voltages to the cathode electrodes and the gate electrodes, and a positive DC voltage (anode voltage) higher than several thousand volts to the anode electrode. The voltage difference between the cathode electrode and the gate electrode induces an electric field around the electron emission regions, and electrons are emitted from the electron emission regions. The anode voltage attracts the emitted electrons, which collide with the phosphor layer, thereby emitting light.

Since the luminance of the light emission device is in proportion to the anode voltage in the above-described light emission device, increasing the anode voltage improve the luminance of the light emission device. However, the strength of the anode electric field around the electron emission regions also increases and diode emission may occur with increasing anode voltage because the anode electric field directly influences the electron emission regions. Diode emission is a phenomenon in which electrons are unintentionally emitted by the anode electric field.

Also, as the anode voltage increases the possibility of inducing an arc discharge, in the vacuum envelope from a surface of an internal structure or through any remaining gas in the vacuum envelope, also increases. As described above, the light emission device had low high-voltage stability and an upper limit to the anode voltage. Therefore, it is difficult to improve the luminance of known light emission devices.

Furthermore, the effect of the metal reflective layer for improving luminance is limited in a structure in which electrons excite the phosphor layer after passing through the metal reflective layer, which then reflects visible light emitted toward the rear substrate, back to the front substrate. It is because the metal reflective layer is thin, for example, about several thousand Å, and includes tiny holes for letting electron beams pass therethrough and for evaporation of an intermediate layer material.

The intermediate layer is disposed between the phosphor layer and the metal reflective layer in a process of forming the light emission unit. The intermediate layer is removed through baking, thereby providing a fine gap between the phosphor layer and the metal reflective layer. The intermediate layer reduces the roughness of the metal reflective layer by preventing the metal reflective layer from being influenced by the surface roughness of the phosphor layer.

### SUMMARY OF THE INVENTION

Exemplary embodiments provide a light emission device having advantages of suppressing arc discharge by increasing high-voltage stability and of improving the luminance thereof by increasing an anode voltage and the reflection efficiency of a metal reflective layer, and a display device using the light emission device as its light source.

In an exemplary embodiment, a light emission device includes (i) front and rear substrates disposed to face each other, (ii) an electron emission unit disposed in one surface of the front substrate facing the rear substrate and having a plurality of electron emission elements, and (iii) a light emission unit including a metal reflective layer formed on the rear substrate and a phosphor layer formed on one surface of the metal reflective layer facing the front substrate. Each of the electron emission elements includes (i) first electrodes spaced apart from each other by a predetermined interval along a first direction of the front substrate, (ii) second electrode arranged between the first electrodes along the first direction, and (iii) first electron emission regions electrically connected to the first electrodes and having a thickness thinner than that of the first electrodes.

The metal reflective layer may be formed with a thickness of about 0.1 to 4 μm. The first electrodes and the first electron emission regions may have a thickness difference of about 1 to 10 μm, and the first electrodes and the second electrodes may be disposed at intervals of about 30 to 200 μm. The first electron emission regions may be formed along a length direction of the first electrodes in a discontinuous pattern.

The electron emission element may further include second electron emission regions electrically connected to the second electrodes and having a thickness thinner than that of the second electrodes. The second electrodes and the second electron emission regions may have a thickness difference of about 1 to 10 μm and the first electron emission regions and the second electron emission regions may be disposed at intervals of about 3 to 20 μm. The second electron emission regions may be formed along a length direction of the second electrodes in a discontinuous pattern.

The first electrodes and the second electrodes may respectively receive a scan driving voltage and a data driving voltage in a first period and respectively receive a data driving voltage and a scan driving voltage in a second period. The first electron emission regions and the second electron emission regions may include carbide-derived carbon.

In another exemplary embodiment, a display device includes (i) a display panel for displaying an image, and (ii) a light emission device for providing light to the display panel. The light emission device includes (i) front and rear substrates disposed to face each other, (ii) an electron emission unit disposed in one surface of the front substrate facing the rear substrate and having a plurality of electron emission elements, and (iii) a light emission unit including a metal reflective layer formed on the rear substrate and a phosphor layer formed on one surface of the metal reflective layer facing the front substrate. Each of the electron emission elements includes (i) first electrodes spaced apart from each other by a predetermined interval along a first direction of the front substrate, (ii) second electrode arranged between the first electrodes along the first direction, and (iii) first electron emission regions electrically connected to the first electrodes and having a thickness thinner than that of the first electrodes.

The display panel may have first pixels and the light emission device may include second pixels. The second pixels may be fewer in number than the first pixels, and each of the second pixels may independently emit light corresponding to grayscales of the first pixels. One of the electron emission elements may be disposed at each of the second pixels, and the display panel may be a liquid crystal display panel.

Some embodiments of a light emission device comprise a front substrate and a rear substrate sealed together at their peripheries. A light emission unit comprising a reflective layer, which is an anode, is disposed on an inside surface of the rear substrate, and a phosphor layer disposed on the reflective layer. Electron emission units comprising electron emission elements are disposed on an inside surface of the front substrate. Each electron emission element comprises a first electrode, a second electrode, and first electron emission regions disposed on either side of and coupled to the first electrode. Some embodiments also comprise second electron emission regions disposed on either side of and coupled to the second electrode. Electron emission regions are thinner than the corresponding electrode. Some embodiments permit application of higher anode voltages, thereby increasing the luminance of the device, while exhibiting reduced diode emission and arcing.

Some embodiments light emission device comprising: a front substrate and a rear substrate facing each other; an electron emission unit disposed on a surface of the front substrate facing the rear substrate, the electron emission unit comprising a plurality of electron emission elements; and a light emission unit comprising a metal reflective layer disposed on the rear substrate and a phosphor layer disposed on a surface of the metal reflective layer facing the front substrate. Each electron emission element comprises: a first electrode, wherein the first electrodes of the plurality of electron emission elements of the electron emission unit are disposed with a predetermined spacing therebetween along a first direction of the front substrate, a second electrode, wherein the second electrodes of the plurality of electron emission elements are disposed between the first electrodes along the first direction, and first electron emission regions electrically coupled to the first electrode, wherein the first electron emission regions are thinner than the first electrode.

In some embodiments, the metal reflective layer is from about 0.1 μm to about 4 μm thick.

In some embodiments, a difference in thickness between the first electrode and the first electron emission regions is from about 1 μm to about 10 μm.

In some embodiments, the first electrode and the second electrode are disposed at from about 30 μm to about 200 μm apart.

In some embodiments, the first electron emission regions are discontinuous along a length direction of the first electrode.

In some embodiments, the electron emission element further comprises second electron emission regions electrically coupled to the second electrode, and the second electron emission regions are thinner than the second electrode. In some embodiments, a difference in thickness between the second electrode and each second electron emission region is from about 1 μm to about 10 μm.

In some embodiments, proximal first electron emission regions and second electron emission regions are disposed at from about 3 μm to about 20 μm apart. In some embodiments, the second electron emission regions are discontinuous along a length direction of the second electrode.

In some embodiments, a scan driving voltage and a data driving voltage are applied to the first electrode and the second electrode, respectively, in a first time period, and a data driving voltage and a scan driving voltage are applied to the first electrode and the second electrode, respectively, in a second time period.

In some embodiments, at least one of the first electron emission regions and the second electron emission regions comprise carbide-derived carbon.

In some embodiments, the electron emission unit further comprises a first connection electrode coupled to first ends of the first electrodes of the plurality of electron emission elements, and together with the first electrodes, forming a first electrode set, and a second connection electrode coupled to first ends of the second electrodes of the plurality of electron emission elements, and together with the second electrodes, forming a second electrode set.

In some embodiments, the electron emission unit further comprises: a first wire extending in a first direction of the front substrate, wherein the first wire is coupled to the first connection electrode of the electron emission elements, and a second wire extending in a second direction of the front substrate, wherein the second direction is generally perpendicular to the first direction, and wherein the second wire is coupled to the second connection electrode of the electron emission elements, and the first wire and the second wire are insulated from each other.

Some embodiments provide a display device comprising: a display panel configured for displaying an image; and a light emission device configured for providing light to the display panel. The light emission device comprises: a front substrate and a rear substrate facing each other; an electron emission unit disposed on a surface of the front substrate facing the rear substrate, the electron emission unit comprising a plurality of electron emission elements; and a light emission unit comprising a metal reflective layer disposed on the rear substrate and a phosphor layer disposed on a surface of the metal reflective layer facing the front substrate. Each electron emission element comprises: a first electrode, wherein the first electrodes of the plurality of electron emission elements of the electron emission unit are disposed with a predetermined spacing therebetween along a first direction of the front substrate, a second electrode, wherein the second electrodes of the plurality of electron emission elements are disposed between the first electrodes along the first direction, and first electron emission regions electrically coupled to the first electrode, wherein the first electron emission regions are thinner than the first electrode.

In some embodiments, the metal reflective layer is from about 0.1 μm to about 4 μm thick.

In some embodiments, the electron emission element further comprises second electron emission regions electrically coupled to the second electrode, and the second electron emission regions are thinner than the second electrode.

In some embodiments, a difference in thickness between the first electrode and the first electron emission regions is from about 1 μm to about 10 μm, and a difference in thickness between the second electrode and the second electron emission regions is from about 1 μm to about 10 μm.

In some embodiments, the first electrode and the second electrode are disposed at from about 30 μm to about 200 μm apart.

In some embodiments, proximal first electron emission regions and second electron emission regions are disposed at from about 3 μm to about 20 μm apart. In some embodiments, at least one of the first electron emission regions and the second electron emission regions are discontinuous along a length direction of the first electrodes and the second electrodes, respectively.

In some embodiments, the display panel comprises first pixels, the light emission device comprises fewer second pixels than the display panel comprises first pixels, and each of the second pixels is configured to independently emit light corresponding to a gray level of a corresponding first pixel. In some embodiments, an electron emission element is disposed under each of the second pixels.

In some embodiments, the display panel is a liquid crystal display panel.

### BRIEF DESCRIPTION OF THE DRAWINGS

FIG. 1 is a partial cross-sectional view of a light emission device according to a first exemplary embodiment.

FIG. 2 is a partial bottom view of an electron emission unit shown in FIG. 1.

FIG. 3 is a perspective view of an electron emission element shown in FIG. 2.

FIG. 4 is a cross-sectional view taken along the line II-II of FIG. 2.

FIG. 5 is a partial cross-sectional view of a light emission device according to a second exemplary embodiment.

FIG. 6 is a partial bottom view of an electron emission unit shown in FIG. 5.

FIG. 7 is a perspective view of an electron emission element shown in FIG. 6.

FIG. 8 and FIG. 9 are partial cross-sectional views of a light emission device according to the second exemplary embodiment.

FIG. 10A to FIG. 10C are partial cross-sectional views illustrating the first method of manufacturing an electron emission element in a light emission device according to the second exemplary embodiment.

FIG. 11A to FIG. 11C are partial cross-sectional views illustrating the second method of manufacturing an electron emission element in a light emission device according to the second exemplary embodiment.

FIG. 12 is an exploded perspective view of a display device using the light emission device of the first or second exemplary embodiment as its light source.

FIG. 13 is a partial cross-sectional view of a display panel shown in FIG. 12.

### DETAILED DESCRIPTION OF CERTAIN EMBODIMENTS

Certain embodiments will now be described more fully with reference to the accompanying drawings, in which exemplary embodiments are shown. The disclosure may, however, be embodied in many different forms and should not be construed as being limited to the embodiments set forth herein; rather these embodiments are provided so that this disclosure will be thorough and complete, and will fully convey the concepts thereof to those skilled in the art.

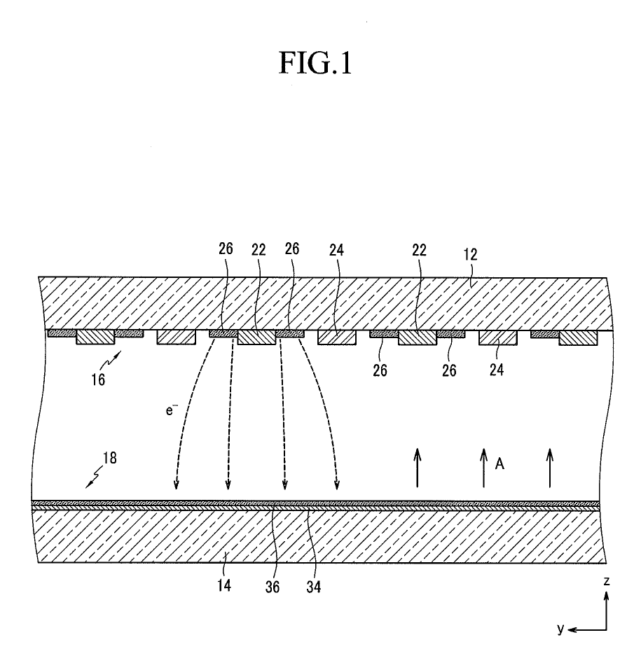

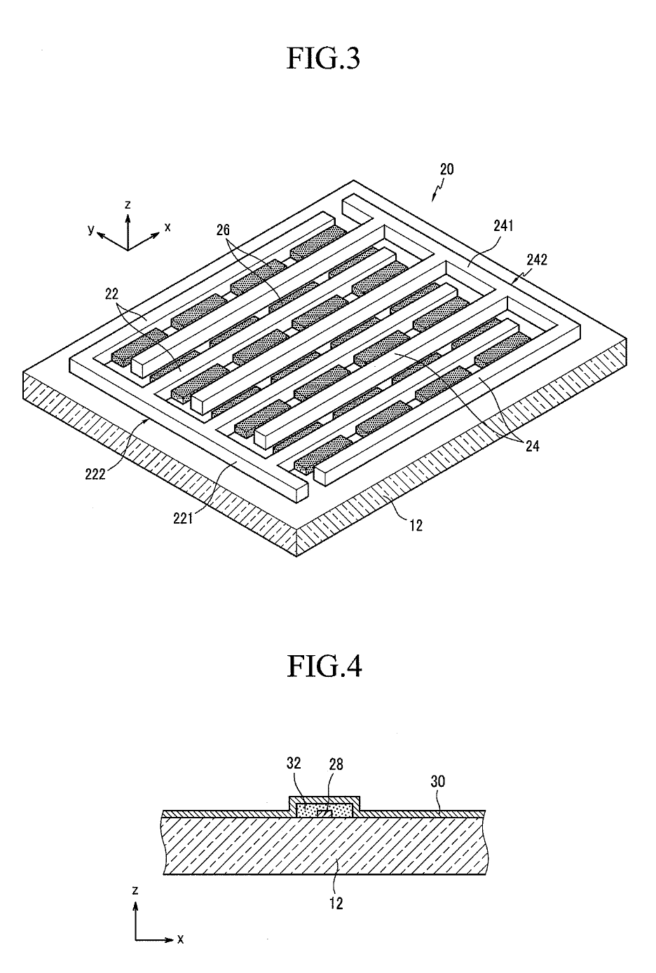

A light emission device 100 according to a first exemplary embodiment will be described with reference to FIGS. 1 to 3. In FIG. 3, the inner surface of a front substrate 12 is illustrated facing upward.

Referring to FIG. 1 to FIG. 3, a light emission device 100 of the present exemplary embodiment includes a front substrate 12 and a rear substrate 14 facing each other, generally in parallel, with a predetermined gap therebetween. The front and rear substrates 12 and 14 are sealed together along their peripheries with a sealing member (not shown), and the inner space therebetween is evacuated to a pressure of about 10-6 Torr. Therefore, the front and rear substrates 12 and 14 and the sealing member together form a vacuum envelope.

Inside the sealing member, each of the front and rear substrates 12 and 14 may be divided into an active area, from which visible light is emitted, and a non-active area surrounding the active area. An electron emission unit 16 for emitting electrons is provided on an inner surface of the front substrate 12 in the active area, and a light emission unit 18 for emitting the visible light is provided on an inner surface of the rear substrate 14 in the active area.

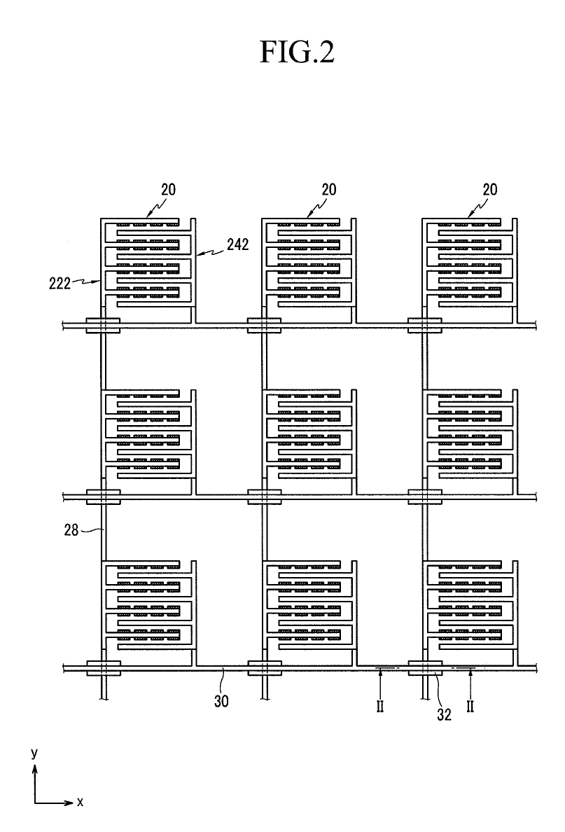

As illustrated in FIGS. 2 and 3, each electron emission unit 16 includes a plurality of electron emission elements 20 in which the emission current amounts are independently controlled. The light emission unit 18 is located on the rear substrate 14 rather than on the front substrate 12 (FIG. 1) in the illustrated embodiment, and in operation it receives electrons from the electron emission elements 20 to emit visible light. The visible light emitted from the light emission unit 18 passes through the front substrate 12 and is radiated to the outside of the light emission device 100.

In the present exemplary embodiment, the electron emission unit 16 reduces the effect of the anode electric field on the electron emission regions to improve the high voltage stability of the light emission device 100. The light emission unit 18 improves the reflection efficiency of the visible light to enhance the luminance of the light emission device 100.

Each of the electron emission elements 20 includes first electrodes 22 spaced apart from each other by a predetermined interval along a first direction of the front substrate 12 (e.g., the y-axis direction of the drawings), second electrodes 24 arranged between the first electrodes 22 along the first direction, and electron emission regions 26 disposed on the sides of the first electrodes 22 that face the second electrodes 24. The electron emission regions 26 are thinner than the first electrodes 22 in the illustrated embodiment. The first and second electrodes 22 and 24 are disposed generally in parallel with each other.

The first electrodes 22 become cathode electrodes to provide a current to the electron emission regions 26, and the second electrode 24 become gate electrodes that induce electron emission by forming an electric field around the electron emission regions 26 due to the voltage difference between the first and second electrodes 22 and 24. The electron emission regions 26 are separated from the second electrodes 24 at a predetermined distance so as not to short-circuit with the second electrodes 24.

The electron emission regions 26 may be formed in a linear pattern along a length direction of the first electrodes 22 or in a discontinuous pattern along the length direction of the first electrodes 22 as shown in FIG. 2. In the case of the latter, it may be possible to expose the transparent front substrate 12 between the electron emission regions 26 to improve visible light transmittance.

As shown in FIG. 3, a first connection electrode 221 is provided on first ends of the first electrodes 22 such that the first electrodes 22 and the first connection electrode 221 together comprise a first electrode set 222. A second connection electrode 241 is provided on first ends of the second electrodes 24 such that the second electrodes 24 and the second connection electrode 241 together comprise a second electrode set 242.

The first and second electrodes 22 and 24 are formed on the front substrate 12 with a thickness greater than that of the electron emission regions 26. To do so, in some embodiments, the first and second electrodes 22 and 24 are formed through a so-called thick film process such as screen printing or laminating rather than through a thin film process such as sputtering or vacuum deposition.

The electron emission regions 26 may include materials that emit electrons when an electric field is applied in a vacuum, such as a carbon-based material and/or a nanometer-sized material. For example, the electron emission regions 26 may include at least one of carbon nanotubes, graphite, graphite nanofiber, diamond, diamond-like carbon, fullerene (C₆₀), silicon nanowire, and combinations thereof.

Alternatively, the electron emission regions 26 may include carbide-derived carbon. The carbide-derived carbon can be manufactured during a process of extracting non-carbon elements from a carbide compound, for example, by a thermal chemical reaction of the carbide compound with a halide-containing gas.

The carbide compound may comprise at least one of SiC₄, B₄C, TiC, ZrCₓ, Al₄C₃, CaC₂, TiₓTa_{y}C_{y}, MoₓW_{y}C, TiNₓC_{y}, and ZrNₓC_{y}. The halide-containing gas may be Cl₂, TiCl₄, and/or F₂. Embodiments of electron emission regions 26 including carbide-derived carbon have excellent electron emission uniformity and a long life-span.

Referring to FIG. 2, the electron emission elements 20 are arranged in parallel with each other at predetermined intervals on the active area of the front substrate 12. The first wires 28 and the second wires 30 are disposed between the electron emission elements 20 to apply a driving voltage to the first electrodes 22 and the second electrodes 24.

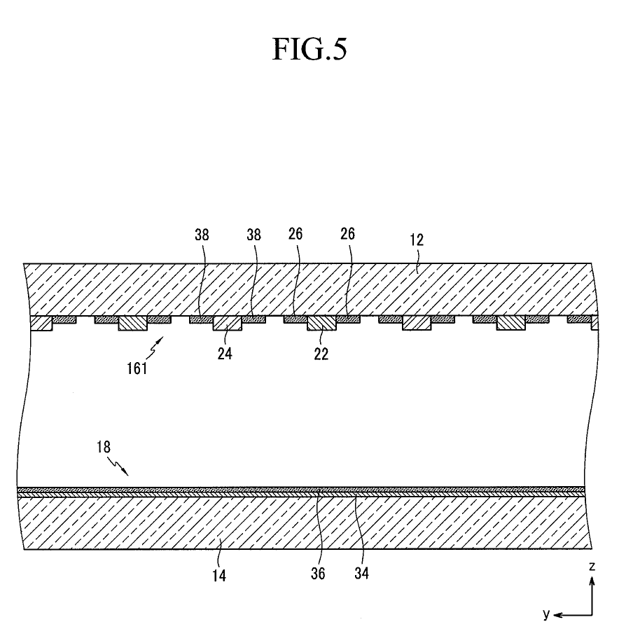

FIG. 4 is a cross-sectional view taken along the line II-II of FIG. 2.

Referring to FIG. 2 and FIG. 4, the first wires 28 are formed along the first direction of the front substrate 12 (e.g., the y-axis direction in the drawings) and are electrically connected with the first electrode set 222 of the electron emission elements 20, which is disposed along the same direction. The second wires 30 are formed along a second direction, generally perpendicular to the first direction (e.g., the x-axis direction in the drawings) in the illustrated embodiments, and are electrically connected with the second electrode set 242 of the electron emission elements 20, which is disposed along the same direction.

In addition, an insulation layer 32 is formed between the first and second wires 28 and 30 at the area where the first and second wires 28 and 30 cross each other to prevent the first and second wires 28 and 30 from short-circuiting. The insulation layer 32 is wider than the first and second wires 28 and 30 in the illustrated embodiment.

Referring again to FIG. 1, the light emission unit 18 includes a metal reflective layer 34 formed on the inner surface of the rear substrate 14, and a phosphor layer 36 formed on a surface of the metal reflective layer 34 facing the front substrate 12.

The phosphor layer 36 may be made of a mixture of red, green, and blue phosphors to collectively emit white light and is disposed on the entire active area of the rear substrate 14 in the illustrated embodiment. The metal reflective layer 34 operates as an anode electrode by receiving an anode voltage from a power supply outside the vacuum envelope.

In the present exemplary embodiment, the metal reflective layer 34 comprises a metal film having a large thickness and density because it is not necessary to transmit electron beams. The metal reflective layer 34 may be formed by laminating a metal sheet, for example, an aluminum sheet, on the rear substrate 14 with a thickness of approximately 0.1 to 4 μm.

In embodiments in which the metal reflective layer 34 is less than about 0.1 μm thick, most of the light incident on the metal reflective layer 34 passes through the metal reflective layer 34, deteriorating the light reflection effect of the metal reflective layer 34. It is possible to form the metal reflective layer 34 at more than about 4 μm thick, but, in some of these embodiments, the light reflection effect does not improve, while the material cost increases. In some embodiments, a metal reflective layer 34 disposed on the rear substrate 14 exhibits better light reflection efficiency than a metal reflective layer disposed on the front substrate in a light emission device.

In addition, spacers (not shown) are disposed between the front substrate 12 and the rear substrate 14 to provide support against a compression force applied to the vacuum envelope, maintaining a distance between the front substrate 12 and the rear substrate 14.

In the light emission device 100 discussed above, each electron emission element 20 and a corresponding part of the phosphor layer 36 together comprise one pixel. The light emission device 100 applies a scan driving voltage to one of the first wire 28 and the second wire 30, a data driving voltage to the other of the first wire 28 and the second wire, and a positive DC voltage (anode voltage) above about 10 kV to the metal reflective layer 34.

Then, an electric field is formed around pixels where a voltage difference between the first and second electrodes 22 and 24 is above a threshold value to emit electrons (represented as e⁻ in FIG. 1) from the electron emission regions 26. The emitted electrons are attracted by an anode voltage applied to the metal reflective layer 34, thereby colliding with the corresponding part of the phosphor layer 36 and emitting light therefrom.

In this process, substantially all of the visible light emitted from the phosphor layer 36 is directed to the front substrate 12 by the metal reflective layer 34 and does not pass through the rear substrate 14. Accordingly, the visible light does not leak out of the rear substrate 14. In FIG. 1, for the purpose of convenience, the electrons are shown emitted from some of the electron emission regions 26 and the direction in which the visible light is emitted is represented by arrows A.

In the above light emission device 100, the first and second electrodes 22 and 24 are formed thicker than the electron emission regions 26. Therefore, the first electrodes 22 and the second electrodes 24 change the distribution of the electric field around the electron emission regions 26 in such a way as to reduce the effect of the anode electric field on the electron emission regions 26.

Accordingly, even when more than about 10 kV of anode voltage is applied to the metal reflective layer 34 in order to increase the luminance of the light emission device 100, the first electrodes 22 and the second electrodes 24 shield the anode electric field around the electron emission regions 26, thereby effectively suppressing diode emission by the anode electric field.

As a result, the light emission device 100 according to the present exemplary embodiment can increase the luminance thereof by raising the anode voltage and can accurately control the luminance pixel-by-pixel by suppressing diode emission. Also, the light emission device 100 can minimize arc occurrence rates by increasing high voltage stability, thereby suppressing inner structural damage caused by arc discharge.

Furthermore, since the light emission unit 18 is disposed on the rear substrate 14, and the metal reflective layer 34 is formed with a thickness of about 1 to 4 μm and with a high density, the entire visible light emitted from the phosphor layer 36 can be directed to the front substrate 12. Therefore, the light emission device 100 can implement high luminance and prevent the visible light from leaking out of the rear substrate 14.

The first and second electrodes 22 and 24 may be formed with about the same thickness, and at a thickness approximately 1 to 10 μm higher than the electron emission regions 26. If the thickness difference between the first electrodes 22 and the electron emission regions 26 is less than about 1 μm, the shield effect of the anode electric field on the electron emission regions 26 may decrease and the high voltage stability of the light emission device 100 may be reduced in some embodiments. If the thickness difference between the first electrodes 22 and the electron emission regions 26 is more than about 10 μm, the emission efficiency of the electron emission regions 26 may be reduced in some embodiments, causing an increase of a driving voltage.

In embodiments in which the electron emission regions 26 contain carbide-derived carbon formed through screen printing, the electron emission regions 26 may be formed with a thickness of approximately 1 to 2 μm. In some embodiments in which the thickness of the electron emission regions 26 is substantially less than about 1 μm, it may be difficult to form the electron emission regions 26. In some embodiments in which the thickness is more than about 2 μm, the enhanced electric field effect may be reduced, thereby reducing the emission efficiency of the electron emission regions 26. The diameter of the carbide-derived carbon may be approximately 1 μm.

In some embodiments in which the thickness of the electron emission regions 26 is approximately 1 to 2 μm, the first and second electrodes 22 and 24 should be formed with a thickness of approximately 3 to 12 μm to provide the desired thickness difference between the first electrodes 22 and the electron emission regions 26 of approximately 1 to 10 μm.

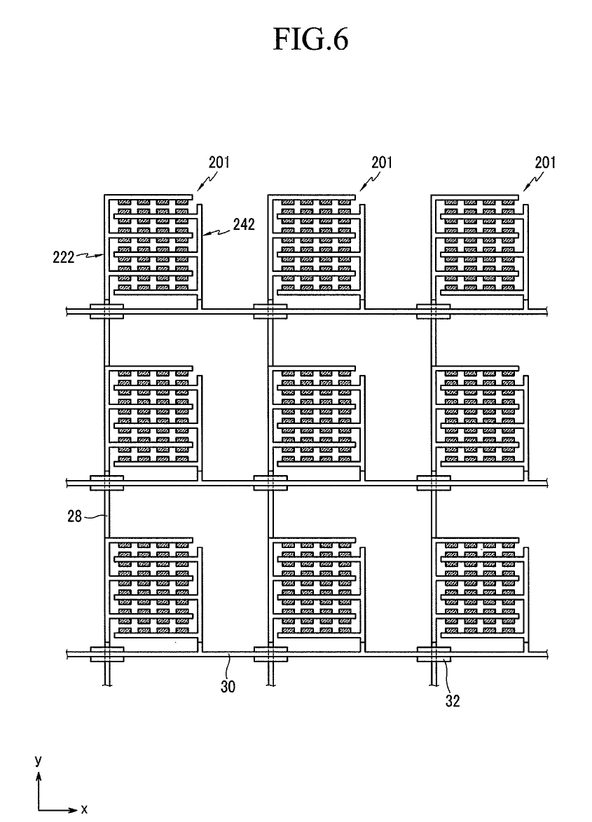

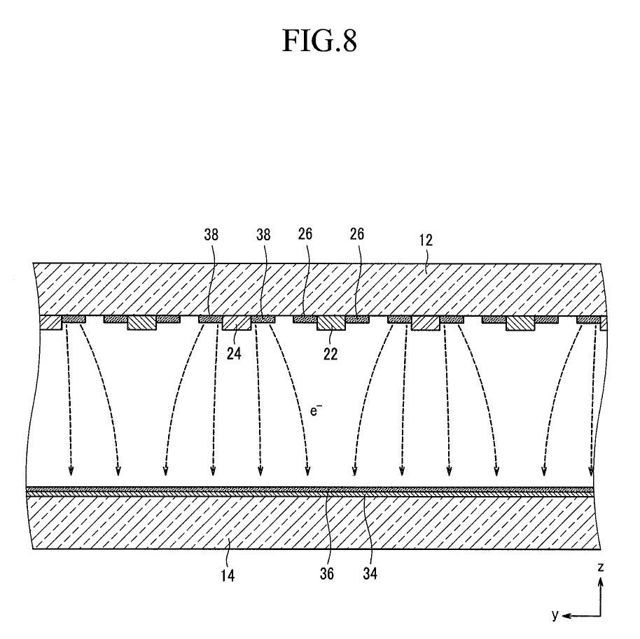

A light emission device 102 according to a second exemplary embodiment will be described with reference to FIGS. 5 to 7. In FIG. 7, the inner surface of a front substrate is illustrated facing upward.

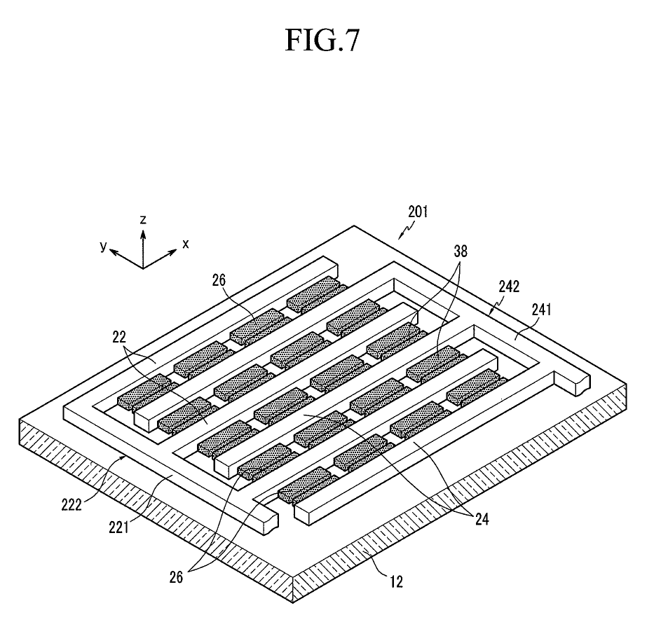

Referring to FIG. 5 to FIG. 7, a light emission device 102 of the present exemplary embodiment has a similar configuration as the light emission device 100 of the first exemplary embodiment, except for the structure of electron emission elements 201 to be explained later. Like reference numerals are used for like elements to the first exemplary embodiment. The reference numeral 161 in FIG. 5 and FIG. 6 designates an electron emission unit.

In the present exemplary embodiment, each of the electron emission elements 201 includes first electrodes 22 spaced apart from each other by a predetermined interval along a first direction of the front substrate 12 (e.g., the y-axis direction of the drawings), second electrodes 24 arranged between the first electrodes 22 along the first direction, electron emission regions 26 disposed on the sides of the first electrodes 22 that face the second electrodes 24, and electron emission regions 38 disposed on the sides of the second electrodes 24 that face the first electrodes 22.

Hereinafter, the term “first electron emission regions” designate the electron emission regions 26 coupled to the first electrodes 22, and the term “second emission regions” designate the electron emission regions 38 coupled to the second electrodes 24. The first electron emission regions 26 and the second electron emission regions 38 are formed at a smaller thickness than that of the first electrodes 22 and the second electrodes 24.

Referring to FIG. 7, a first connection electrode 221 is provided on first ends of the first electrodes 22 such that the first electrodes 22 and the first connection electrode 221 together comprise a first electrode set 222. A second connection electrode 241 is provided on first ends of the second electrodes 24 such that the second electrodes 24 and the second connection electrode 241 together comprise a second electrode set 242. The first and second electron emission regions 26 and 38 are separated from each other so as not to short-circuit with each other.

As in the first exemplary embodiment, the first and second electrodes 22 and 24 may be formed with a thickness about 1 to 10 μm greater than the first and second electron emission regions 26 and 38. The first and second electron emission regions 26 and 38 may be formed with a thickness of approximately 1 to 2 μm, and the first and second electrodes 22 and 24 may be formed at a thickness of approximately 3 to 12 μm.

The first and second electron emission regions 26 and 38 may be spaced from each other at a distance of about 3 to 20 μm. In some embodiments in which the distance between the first and second electron emission regions 26 and 38 is less than about 3 μm, a short-circuit may occur and the manufacturing cost may increase due to fine patterning. In some embodiments in which the distance between the first and second electron emission regions 26 and 38 is more than about 20 μm, the emission efficiency of the first and second electron emission regions 26 and 38 may be reduced, resulting in an increased driving voltage.

The first and second electron emission regions 26 and 38 may be formed in a linear pattern along a length direction of the first and second electrodes 22 and 24, or in a discontinuous pattern along the length direction of the first and second electrodes 22 and 24, as shown in FIG. 7. In the latter case, it may be possible to expose the transparent front substrate 12 between the first and second electron emission regions 26 and thereby 38 improve the transmittance of visible light.

The light emission device 102 of the present exemplary embodiment may apply a driving method in which a scan driving voltage and a data driving voltage are alternately applied to the first and second electrodes 22 and 24. Then, electrodes to which a lower voltage between the scan and data driving voltages is applied become cathode electrodes, and the electrodes to which a higher voltage is applied become gate electrodes.

In other words, during a first period, a scan driving voltage may be applied to the first electrodes 22 through a first wire 28 (FIG. 6) and a data driving voltage applied to the second electrodes 24 through a second wire 30 (FIG. 6). Then, during a second period, a scan driving voltage may be applied to the second electrodes 24 through the second wire 30 and a data driving voltage to the first electrodes 24 through the first wire 28.

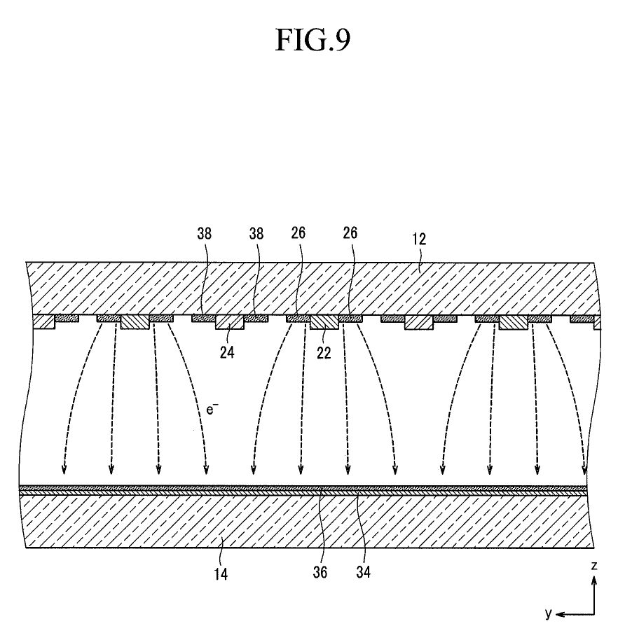

If the scan driving voltage is higher than the data driving voltage, the second electrodes 24 become cathode electrodes, and electrons (represented as e⁻ in FIG. 8) are emitted from the second electron emission regions 38, thereby irradiating the phosphor layer 36 during the first period. During the second period, the first electrodes 22 become cathode electrodes, and electrons (represented as e⁻ in FIG. 9) are emitted from the first electron emission regions 26, thereby irradiating the phosphor layer 36.

By alternately driving the light emission device 102 during the first period and the second period, electrons can be emitted from the first electron emission regions 26 and the second electron emission regions 38 in turn. Using such a driving method, since the load on each electron emission region 26 and 38 is reduced, the life-span of the electron emission regions 26 and 38 can be increased, and the luminance of the light emission device 102 can be improved.

TABLE 1 shows experimental results of the high voltage stability of the light emission device according to the variation in the thickness difference between the electrodes 22 and 24 and the electron emission regions 26 and 38. The high voltage stability indicates a maximum anode voltage under which arc discharge and diode emission do not occur while the light emission device is being driven. In the light emission device used for this experiment, the data driving voltage is 0 V.

TABLE 1

| | Thickness difference | Gap between the | | | |
|---|---|---|---|---|---|
| | between electrodes | first and second | Scan | Current | High |
| | and electron | electron emission | driving | density of | voltage |
| | emission regions | regions | voltage | electron beam | stability |
| | (μm) | (μm) | (V) | (μm/cm²) | (kV) |
| First embodiment | 3 | 5 | 55 | 6.2 | 15 |
| Second embodiment | 5 | 8 | 110 | 6.3 | 15 |
| Third embodiment | 3 | 10 | 70 | 6.7 | 15 |
| Fourth embodiment | 3 | 10 | 80 | 6.48 | 15 |
| Fifth embodiment | 4 | 10 | 105 | 6.32 | 15 |
| First comparative | 0.3 | 10 | 100 | 6.7 | 4.6 |
| example | | | | | |
| Second comparative | 0.3 | 10 | 99 | 6.13 | 5.4 |
| example | | | | | |

The first and second comparative examples, in which the thickness difference between the electrodes 22 and 24 and electron emission regions 26 and 38 is less than 1 μm, have a lower shielding effect on the anode electric field. The high voltage stabilities of the first and second comparative examples are both below 6 kV. In contrast, in exemplary embodiments 1 to 5, in which the thickness difference between the electrodes 22 and 24 and electron emission regions 26 and 38 is between about 1 to 10 μm, an anode voltage of 15 kV may be applied to the metal reflection layer 34 without exhibiting arc discharge and diode emission.

Meanwhile, in the afore-mentioned first and second exemplary embodiments, as the distance between each first electrode 22 and second electrode 24 becomes greater, the shielding effect of the anode electric field on the electron emission regions 26 and 38 decreases. The first and second electrodes 22 and 24 may be separated from each other at a distance of about 30 to 200 μm.

In some embodiments in which the distance between each first electrode 22 and second electrode 24 is less than about 30 μm, the shielding effect on the anode electric field at the electron emission regions 26 and 38 can be excessive, thereby reducing the emission efficiency of the electron emission regions 26 and 38. If the distance between each first electrode 22 and second electrode 24 is over about 200 μm, the shielding effect on the anode electric field at the first and second electrodes 22 and 24 may be reduced. Then, the high voltage stability of the light emission devices 100 and 102 may also be reduced, thereby precluding application of a high voltage to the metal reflective layer 34. Therefore, it becomes hard to realize high luminance in some embodiments.

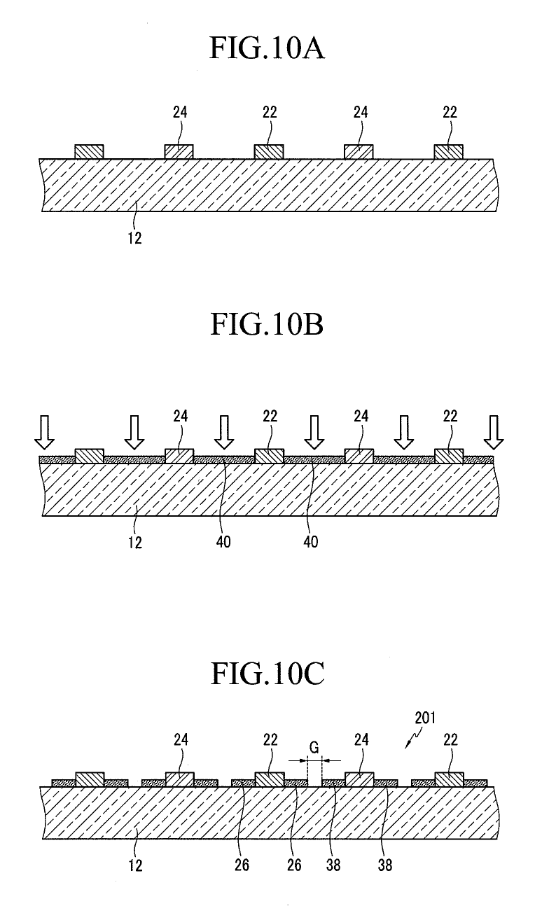

Next, the first method of manufacturing an electron emission element of the light emission device in the afore-mentioned second exemplary embodiment will be described with respect to FIG. 10A to FIG. 10C.

Referring to FIG. 10A, a conductive layer is formed by screen-printing a metal paste on the front substrate 12, and the first and second electrodes 22 and 24 are simultaneously formed by patterning the conductive layer. The metal paste may include silver (Ag). The first and second electrodes 22 and 24 may be formed at a thickness of about 3 to 12 μm and may be spaced at a distance of about 30 to 200 μm from each other.

Referring to FIG. 10B, an electron emission layer 40 is formed between the first and second electrodes 22 and 24. The electron emission layer 40 is formed by a method comprising: (a) screen-printing a paste mixture including an electron emission material and a photosensitive material on the front substrate 12, (b) applying ultraviolet (UV) radiation from the outer surface of the front substrate 12 to harden a predetermined part of the mixture, and (c) removing the unhardened part of the mixture through development.

As described above, the electron emission material may include at least one of carbon nanotubes, graphite, graphite nanofiber, diamond, diamond-like carbon, fullerene, silicon nanowire, and combinations thereof. Alternatively, carbide-derived carbon may be used as the electron emission material.

When the electron emission layer 40 is formed, the thickness of the electron emission layer 40 is controlled to be smaller than the first electrodes 22 and the second electrodes 24 by controlling a printing thickness of the mixture and an irradiation time of the ultraviolet radiation. The electron emission layer 40 may be formed at a thickness of about 1 to 2 μm.

Then, the first electron emission regions 26 and the second electron emission regions 38 are formed as shown in FIG. 10C by removing a center part of the electron emission layer 40 by irradiating with a laser, for example, from a direction indicated by the arrows in FIG. 10B. The first electron emission regions 26 and the second electron emission regions 38 may be disposed at intervals of about 3 to 20 μm, as indicated by the distance G in FIG. 10C. Then, the electron emission element 201 is completely manufactured through the above described procedure.

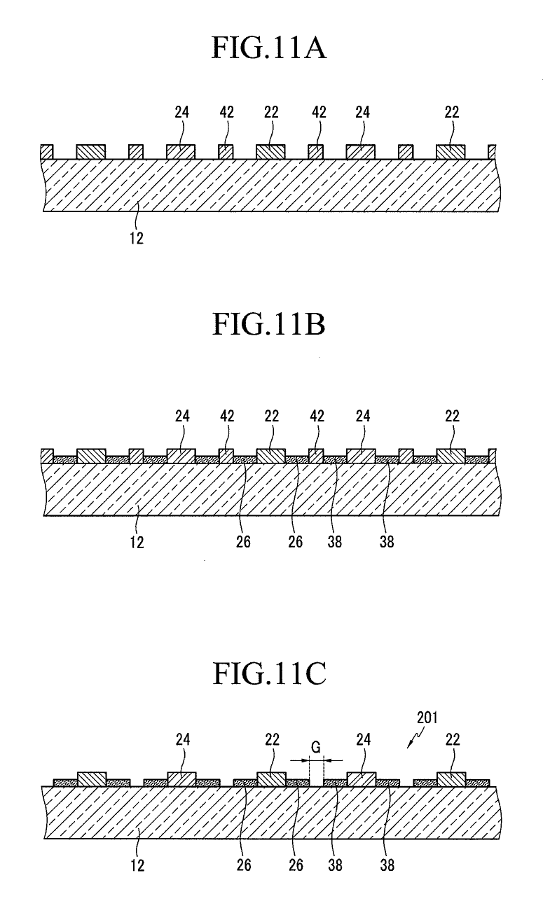

Hereinafter, the second method of manufacturing an electron emission element in the light emission device according to the second exemplary embodiment will be described with reference to FIG. 11A to FIG. 11C.

Referring to FIG. 11A, a conductive layer is formed by laminating a sheet of a suitable material on the front substrate 12. The first and second electrodes 22 and 24 and a sacrifice layer 42 are formed at the same time by patterning the conductive layer. Alternatively, the first and second electrodes 22 and 24 and the sacrifice layer 42 may be formed at the same time by laminating a patterned metal sheet on the front substrate 12. The metal sheet may be an aluminum sheet having a thickness of about 3 to 12 μm.

Referring to FIG. 11B, the first electron emission region 26 is formed between the first electrodes 22 and the sacrifice layer 42, and the second electron emission regions 38 are formed between the second electrodes 24 and the sacrifice layer 42. The method for fabricating the first electron emission regions 26 and the second electron emission regions 38 is similar to the fabricating method for the electron emission layer 40. Also, the thicknesses of the first and second emission regions 26 and 38 are similar to the thickness of the electron emission layer 40.

Finally, a gap G of about 3 to 20 μm is formed between the first electron emission regions 26 and the second electron emission regions 38 by selectively removing the sacrifice layer 42, as shown in FIG. 11C. As described above, fabrication of the electron emission element 201 is completed by the above described procedure.

As described above, the first electrodes 22 and the second electrodes 24 are thicker than the electron emission regions 26 and 38 in the electron emission element 201. Therefore, the first electron emission regions 26 and the second electron emission regions 38 are in stable contact with the first electrodes 22 and the second electrodes 24, respectively. As a result, the emission efficiency of the electron emission regions 26 and 38 is improved.

Also, embodiments of first electrodes 22 and second electrodes 24 formed by a thick film process have lower resistances than similar electrodes formed by a thin film process. Therefore, the light emission device 102 can reduce the voltage drop of the first electrodes 22 and the second electrodes 24, thereby improving luminance uniformity.

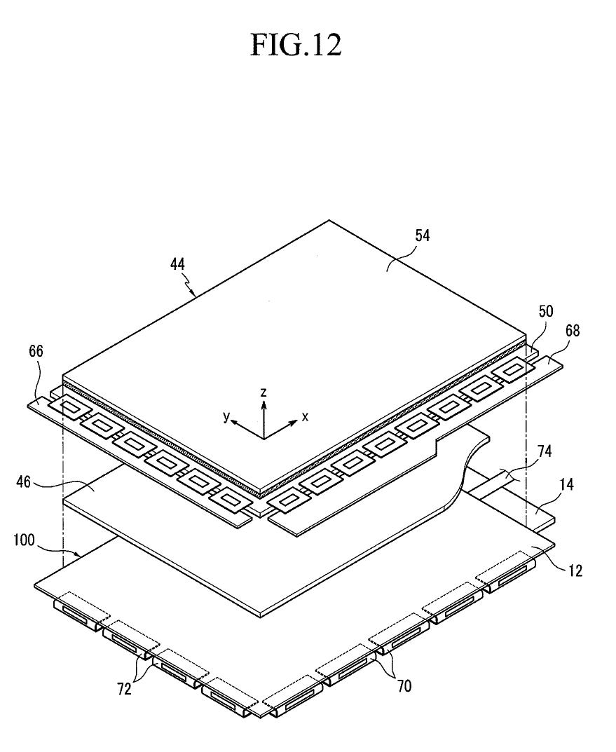

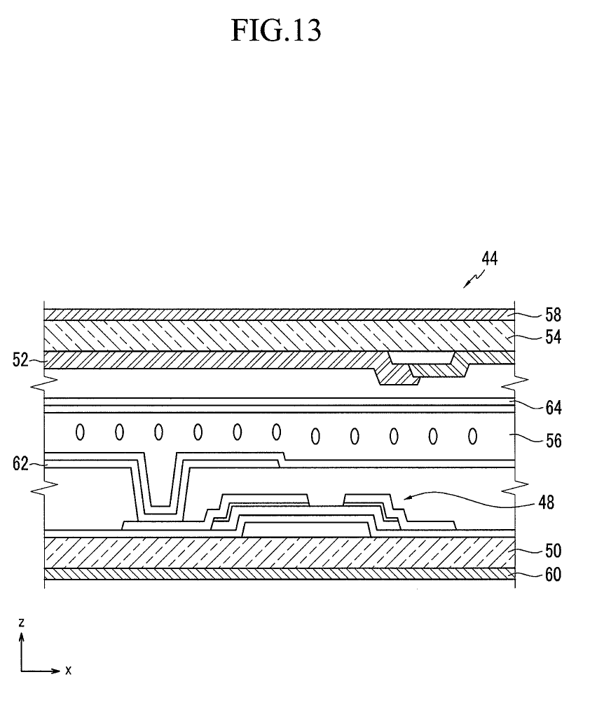

FIG. 12 is an exploded perspective view of a display device 200 using the light emission device of the first or second exemplary embodiment as its light source, and FIG. 13 is a partial cross-sectional view of the display panel shown in FIG. 12.

Referring to FIG. 12, a display device 200 according to the present exemplary embodiment includes a light emission device 100 and a display panel 44 disposed in front of the light emission device 100. A light diffuser 46 may be disposed between the light emission device 100 and the display panel 44 to uniformly diffuse light emitted from the light emission device 100. The light diffuser 46 and the light emission device 100 are spaced apart from each other at a predetermined distance.

Although the display device 200 includes the light emission device 100 according to the first exemplary embodiment as its light source in FIG. 12, the display device 200 may include the light emission device 102 according to the second exemplary embodiment as its light source. The display panel 44 may include a liquid crystal display panel or a non-emissive display panel. Hereinafter, the display device 200 will be described with a liquid crystal display panel as the display panel 44.

Referring to FIG. 13, the display panel 44 includes a lower substrate 50 having a plurality of thin film transistors (TFTs) 48, an upper substrate 54 having color filter layers 52, and a liquid crystal layer 56 interposed between the substrates 50 and 54. An upper polarizing plate 58 and a lower polarizing plate 60 are disposed on the top of the upper substrate 54 and the on bottom of the lower substrate 50, respectively, to polarize light passing through the display panel 44.

A pixel electrode 62 is located at each sub-pixel. Each pixel electrode 62 is controlled by the TFT 48. The pixel electrodes 62 and a common electrode 64 are formed of a transparent conductive material. The color filter layers 52 include red, green, and blue layers arranged to correspond to respective sub-pixels. Three sub-pixels, e.g., the red, green, and blue layers that are located side-by-side, define a single pixel.

When the TFT 48 of a predetermined sub-pixel is turned on, an electric field is formed between the pixel electrode 62 and the common electrode 64. A twisting angle of liquid crystal molecules of a liquid crystal layer 56 is varied thereby. Accordingly, the light transmittance of the corresponding sub-pixel is also varied. The display panel 44 exhibits a predetermined luminance and color for each pixel by controlling the light transmittance of the sub-pixels.

In FIG. 12, reference numeral 66 denotes a gate circuit board assembly for transmitting gate driving signals to each gate electrodes of the TFTs 48, and reference numeral 68 denotes a data circuit board assembly for transmitting data driving signals to each source electrodes of the TFTs 48.

Referring to FIG. 12, the light emission device 100 includes a plurality of pixels, the number of which is less than the number of pixels of the display panel 44, so that one pixel of the light emission device 100 corresponds to two or more pixels of the display panel 44. Each pixel of the light emission device 100 emits light in response to a highest gray level of the gray levels of the corresponding pixels of the display panel 44. The light emission device 100 can represent a gray level of about 2 to 8 bits at each pixel.

For convenience, the pixels of the display panel 44 are referred to as first pixels and the pixels of the light emission device 100 are referred to as second pixels. The first pixels corresponding to one second pixel are referred to as a first pixel group.

In a method for driving the light emission device 100, a signal control unit (not shown) that controls the display panel 44 (i) detects the highest gray level of the first pixel group, (ii) operates a gray level required for emitting light from the second pixel in response to the detected high gray level and converts the operated gray level into digital data, (iii) generates a driving signal of the light emission device 100 using the digital data, and (iv) applies the driving signal to the light emission device 100.

The driving signal of the light emission device 100 includes a scan driving signal and a data driving signal. A scan driving signal is applied to one of the first electrodes and the second electrodes (e.g., the second electrode), and a data driving signal is applied to the other of the first electrodes and the second electrodes (e.g., the first electrodes).

A scan circuit board assembly and a data circuit board assembly may be disposed on the backside of the light emission device 100 for driving the light emission device 100. In FIG. 12, a reference numeral 70 denotes the first connector for connecting the first electrodes and the data circuit board assembly, and a reference numeral 72 denotes the second connector for connecting the second electrodes and the scan circuit board assembly. A reference numeral 74 denotes the third connector for applying an anode voltage to the metal reflective layer.

As discussed above, a method for driving the light emission device 102 according to the second exemplary embodiment can comprise alternately applying a scan driving voltage and a data driving voltage to the first electrodes and the second electrodes. To do so, the first electrodes are coupled to the scan circuit board assembly and the data circuit board assembly through the first connector 70, and the second electrodes are also coupled to the scan circuit board assembly and the data circuit board assembly through the second connector 72.

When an image is displayed on the first pixel group, the corresponding second pixel of the light emission device 100 emits light with a predetermined gray level by synchronizing with the first pixel group. That is, the light emission device 100 independently controls the luminance of each pixel and thus provides a proper intensity of light to the corresponding pixels of the display panel 44 in proportion to the luminance of the first pixel group. As a result, the display device 200 of the present exemplary embodiment can provide an enhanced contrast ratio for the screen, thereby improving the display quality.

Although exemplary embodiments have been described in detail hereinabove, it should be clearly understood that many variations and/or modifications of the basic concepts taught herein fall within the spirit and scope of the present disclosure, as defined by the appended claims and their equivalents.

What is claimed is:

1. A light emission device comprising:
a front substrate and a rear substrate facing each other;
an electron emission unit disposed on a surface of the front substrate facing the rear substrate, the electron emission unit comprising a plurality of electron emission elements; and
a light emission unit comprising a metal reflective layer disposed on the rear substrate and a phosphor layer disposed on a surface of the metal reflective layer facing the front substrate,
wherein each electron emission element comprises:
a first electrode, wherein the first electrodes of the plurality of electron emission elements of the electron emission unit are disposed with a predetermined spacing therebetween along a first direction of the front substrate,
a second electrode, wherein the second electrodes of the plurality of electron emission elements are disposed between the first electrodes along the first direction, and
first electron emission regions electrically coupled to the first electrode, wherein the first electron emission regions are thinner than the first electrode.

2. The light emission device of claim 1, wherein the metal reflective layer is from about 0.1 μm to about 4 μm thick.

3. The light emission device of claim 1, wherein a difference in thickness between the first electrode and the first electron emission regions is from about 1 μm to about 10 μm.

4. The light emission device of claim 1, wherein the first electrode and the second electrode are disposed at from about 30 μm to about 200 μm apart.

5. The light emission device of claim 1, wherein the first electron emission regions are discontinuous along a length direction of the first electrode.

6. The light emission device of claim 1, wherein the electron emission element further comprises second electron emission regions electrically coupled to the second electrode, and the second electron emission regions are thinner than the second electrode.

7. The light emission device of claim 6, wherein a difference in thickness between the second electrode and each second electron emission region is from about 1 μm to about 10 μm.

8. The light emission device of claim 6, wherein proximal first electron emission regions and second electron emission regions are disposed at from about 3 μm to about 20 μm apart.

9. The light emission device of claim 6, wherein the second electron emission regions are discontinuous along a length direction of the second electrode.

10. The light emission device of claim 6, wherein a scan driving voltage and a data driving voltage are applied to the first electrode and the second electrode, respectively, in a first time period, and a data driving voltage and a scan driving voltage are applied to the first electrode and the second electrode, respectively, in a second time period.

11. The light emission device of claim 6, wherein at least one of the first electron emission regions and the second electron emission regions comprise carbide-derived carbon.

12. The light emission device of claim 1, wherein the electron emission unit further comprises a first connection electrode coupled to first ends of the first electrodes of the plurality of electron emission elements, and together with the first electrodes, forming a first electrode set, and a second connection electrode coupled to first ends of the second electrodes of the plurality of electron emission elements, and together with the second electrodes, forming a second electrode set.

13. The light emission device of claim 12, wherein the electron emission unit further comprises:
a first wire extending in a first direction of the front substrate, wherein the first wire is coupled to the first connection electrode of the electron emission elements, and
a second wire extending in a second direction of the front substrate, wherein the second direction is generally perpendicular to the first direction, and wherein the second wire is coupled to the second connection electrode of the electron emission elements, and
the first wire and the second wire are insulated from each other.

14. A display device comprising:
a display panel configured for displaying an image; and
a light emission device configured for providing light to the display panel,
wherein the light emission device comprises:
a front substrate and a rear substrate facing each other;
an electron emission unit disposed on a surface of the front substrate facing the rear substrate, the electron emission unit comprising a plurality of electron emission elements; and
a light emission unit comprising a metal reflective layer disposed on the rear substrate and a phosphor layer disposed on a surface of the metal reflective layer facing the front substrate,
wherein each electron emission element comprises:
a first electrode, wherein the first electrodes of the plurality of electron emission elements of the electron emission unit are disposed with a predetermined spacing therebetween along a first direction of the front substrate,
a second electrode, wherein the second electrodes of the plurality of electron emission elements are disposed between the first electrodes along the first direction, and
first electron emission regions electrically coupled to the first electrode, wherein the first electron emission regions are thinner than the first electrode.

15. The display device of claim 14, wherein the metal reflective layer is from about 0.1 μm to about 4 μm thick.

16. The display device of claim 14, wherein the electron emission element further comprises second electron emission regions electrically coupled to the second electrode, and the second electron emission regions are thinner than the second electrode.

17. The display device of claim 16, wherein a difference in thickness between the first electrode and the first electron emission regions is from about 1 μm to about 10 μm, and a difference in thickness between the second electrode and the second electron emission regions is from about 1 μm to about 10 μm.

18. The display device of claim 16, wherein the first electrode and the second electrode are disposed at from about 30 μm to about 200 μm apart.

19. The display device of claim 16, wherein proximal first electron emission regions and second electron emission regions are disposed at from about 3 μm to about 20 μm apart.

20. The display device of claim 16, wherein at least one of the first electron emission regions and the second electron emission regions are discontinuous along a length direction of the first electrodes and the second electrodes, respectively.

21. The display device of claim 14, wherein the display panel comprises first pixels, the light emission device comprises fewer second pixels than the display panel comprises first pixels, and each of the second pixels is configured to independently emit light corresponding to a gray level of a corresponding first pixel.

22. The display device of claim 21, wherein an electron emission element is disposed under each of the second pixels.

23. The display device of claim 14, wherein the display panel is a liquid crystal display panel.
